(19) United States
(12) Patent Application Publication
(10) Pub. No.: US 2003/0157348 A1
(43) Pub. Date: Aug. 21, 2003

(54) Method for producing a component

(76) Inventor: Nicholas Aldersley, Dachau (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/276,861

(22) PCT Filed: May 17, 2001
(86) PCT No.: PCT/EP01/05653

(30) Foreign Application Priority Data
May 20, 2000 (DE) 100 25 119.6

(51) Int. Cl. B05D 1/36; B32B 15/04

(52) U.S. Cl. 428/457; 427/407.1

(57) ABSTRACT

For producing a component made of a thermoplastic material, particularly for a vehicle, the surface of the component is coated with a material of a lower layer thickness. Subsequently, the application of a decorative surface layer takes place at least to the visible surface of the component. By means of the coating of the component, an inhibiting of the thermal expansion of the thermoplastic material is achieved.

The invention relates to a method of producing a component, particularly for a vehicle.

A known manufacturing process for components made of duroplastic components is the SMC method, SMC being the abbreviation for sheet molding compound. Components produced by means of this process have a low thermal coefficient of expansion. However, the duroplastic starting material is comparatively expensive and the shaping possibilities are limited. The limited recycling possibilities of duroplastic materials are another disadvantage.

In contrast, components made of a thermoplastic material can be produced at more reasonable cost because of the less expensive semifinished materials. In addition, they are easy to process, with multiple possibilities for shaping the components. However, the comparatively high thermal expansion of thermoplastic material is disadvantageous. As a result, in the case of vehicles with body shell components made of a thermoplastic material, as a function of the temperature, different gap measurements occur with respect to adjacent body shell components.

It is an object of the invention to provide a method by means of which the production of a component from a thermoplastic material which has a reduced thermal coefficient of expansion is permitted in order to increase the usage possibilities of such components.

This object is achieved by means of the process steps indicated in claim 1. The characteristics of claim 7 describe the component according to the invention.

By means of the coating of the component produced from a thermoplastic material with a coating having a lower coefficient of thermal expansion, the thermal expansion of the entire component is significantly hindered. By means of the coating with, for example, a metallic material, a reduction of the thermal expansion of the entire component is achieved to approximately the thermal expansion of the metallic coating. According to the invention, a “sandwich composite” is created consisting of the low-cost thermoplastic basic material, the expansion-hindering coating and possibly the decorative surface layer on at least the visible exterior outer surface of the component. This composite material can be used in multiple fashions; among other things, also in a targeted manner as a replacement for components made of a duroplastic material used so far. In addition to the multiple shaping possibilities existing in the processing of thermoplastic materials, the components produced according to the invention are more cost-effective and have a lower weight.

The method according to the invention differs fundamentally from the known coating of components for achieving a decorative surface. The most important of these methods is the application of a chromium layer in order to provide the component with a reflecting glossy appearance. In the vehicle construction, for example, moldings, radiator grilles, etc. are chrome-plated for aesthetic reasons. In contrast, the coating of thermoplastic components according to the invention is used only for preventing the thermal expansion. While the conventional chrome-plating already represents the final visible surface of the component, the expansion-hindering coating of the component according to the invention is purely functional and can correspondingly also take place on a surface of the component which is not visible. If the expansion-hindering coating is in the area of a visible surface of the component, it is subsequently covered with a decorative surface layer.

In vehicle manufacturing, the use of the body shell components produced according to the invention with a reduced thermal expansion permits the maintaining of constantly small joint measurements between adjacent vehicle shell components. Thus, for example, in the front and rear area of a motor vehicle, a uniform joint image can be achieved between the side parts (made of a metallic material) and the bumper modules (made of a thermoplastic material).

Naturally, in addition to vehicle body shell parts, components for the vehicle interior can also be produced according to the method of the invention. In the case of large-surface components, the advantages of the components produced according to the invention are particularly significant.

In addition to components for vehicles, the method according to the invention can also be used in other fields, for example, for components for covering the front wall of buildings.

The coating generally takes place by means of a material which has a lower thermal expansion than the thermoplastic basic material of the component. In particular, metallic materials are suitable for this purpose because they have a higher tensile strength and compression strength and thus, also when the layer thickness is small, can effectively hinder the thermal expansion of the thermoplastic material. The application of the metallic material preferably takes place galvanically, in which case, first, a thin metallic coating makes the surface of the non-conducting thermoplastic material conductive. Additional details of the galvanic method known per se will not be discussed here in detail.

Naturally, the metallic layer can also be applied by any other suitable process. The gluing-on of a metallic foil is mentioned here as an example. In principle, the vapor-depositing of the thermoplastic material is also conceivable with a sufficient layer thickness.

Preferred metallic materials for the coating of the thermoplastic material are copper, nickel and chromium. The layer thickness of the metallic material, in the case of a galvanic application, amounts to, for example, up to approximately 0.03 mm; in the case of the gluing-on of a metallic foil, it amounts to, for example, up to approximately 0.1 mm.

In addition to metallic materials, non-metallic materials, such as synthetic fibers, can also be used for the coating of the thermoplastic materials. Non-metallic materials are glued onto the thermoplastic material, for example, as foils. The layer thickness is a function of the material and may, for example, amount to approximately 1 mm in the case of synthetic fibers.

The expansion inhibiting coating of the component can take place on all sides or in a targeted manner only on one part of the surface, for example, only on the exterior side of the component which, as a rule, is the visible side. When the component is coated on a visible side, the application of the actual decorative surface layer will take place subsequently. When the expansion-inhibiting coating of the component takes place on an invisible side, the application of the decorative surface layer is not necessary if the thermoplastic material as such is to form the visible surface.

The decorative surface layer is applied, for example, by means of a painting process. Naturally, other methods are also conceivable, such as a powder coating or the mounting of an adhesive foil. In the vehicle construction, the application of the surface layer preferably takes place by a painting process, corresponding to the painting process of the remaining vehicle in order to achieve a uniform surface of all components of the vehicle. The surface layer can be applied to the vehicle before or after the mounting of the component.

1. Method of producing a component, particularly for a vehicle,
characterized by
a) producing the component made of a thermoplastic material,
b) coating the component with a material of a small layer thickness which has a lower thermal expansion than the thermoplastic material,
c) applying a decorative surface layer at least to the visible surface of the component in the event that the visible surface was coated with the material of a lower thermal expansion.

2. Method according to claim 1,
characterized in that the coating takes place by means of a metallic material.

3. Method according to claim 2,
characterized in that the coating takes place by means of a galvanic process.

4. Method according to claim 1,
characterized in that the coating takes place by means of a nonmetallic material.

5. Method according to one of the above-mentioned claims, characterized in that the coating takes place by gluing on the material provided as a foil.

6. Method according to one of the above-mentioned claims, characterized in that the application of the decorative surface layer takes place by a painting process.

7. Component made of a thermoplastic material, particularly for a vehicle,
characterized in that the surface of the component has a coating made of a material having a lower heat expansion than the thermoplastic material, at least in the area of its visible surface, the component being covered with a decorative surface layer at least in the event that the covering is situated in the area of the visible surface.
